(19) United States
(12) Patent Application Publication
(10) Pub. No.: US 2005/0132632 A1
(43) Pub. Date: Jun. 23, 2005

(54) Motion-based hunting decoy

(76) Inventor: Tony M. Fisher, Eagle Mountain, UT (US)

Correspondence Address: Michael J. Frodsham;WORKMAN NYDEGGER, 1000 Eagle Gate Tower, 60 East South Temple, Salt Lake City, UT, 84111, US

(21) Appl. No.: 10/744,692

(22) Filed: Dec. 23, 2003

(51) Int. Cl. A01M 31/06

(52) U.S. Cl. 43/3

(57) ABSTRACT

A motion-based decoy stand includes a base and a support axis extending from the base to a distal end. In one embodiment, the distal end can form a point. A mounting assembly includes an attachment interface and a hollow shaft connected to the attachment interface, the hollow shaft sliding about the support axis. The mounting assembly can be attached to a decoy where decoy legs would otherwise be present, and can allow the decoy to move with respect to the base. Mounting means and flexible restraints can be configured between the mounting assembly and the base to ensure the decoy moves within an expected range.

### BACKGROUND OF THE INVENTION

1. The Field of the Invention

Embodiments of the present invention relate to hunting decoys. More specifically, the present invention relates to systems and methods that allow hunting decoys to simulate the movement of live fowl.

2. Background and Relevant Art

Fowl that are looking for a place to rest and/or forage will generally prefer locations that other fowls have already chosen. In particular, fowl tend to be attracted to certain ground locations that the fowl sense is one of greater safety and/or nourishment. Accordingly, hunters looking to attract fowl will setup decoys at a certain location, such as a field, marsh, etc. In general, the decoys are chosen for exhibiting a certain quality, such as a look of realism, that gives live fowl a false perception that other fowl have found a place of safety, and/or nourishment. As such, the design quality of the hunter's decoys can have a significant impact on whether a hunter successfully attracts live fowl. Furthermore, inasmuch as fowl appear to be increasingly adept at spotting decoy artifice, hunters continually seek improved decoy realism.

Recently, manufacturers have tried to improve the realism of their decoys by improving the overall decoy appearance, such as by adding flocking to the decoy. Flock, for example, can give a decoy a softer, more realistic appearance, and will not reflect light in the same way that a shiny plastic model would to live fowl. Unfortunately, if a fowl is sitting perfectly still in a single place, live fowl will still detect the decoy artifice, however realistic the color, shape, or flocking initially appears. As such, other ways manufacturers have tried to improve a decoy's realism is by adding movement to the decoy. In general, one way manufacturers have provided decoys with movement is by implementing motorized systems that make the decoy simulate a bobbing head, fluttering wings, and so forth. While motorized movement systems are generally more realistic than non-motorized counterparts in some cases, unfortunately, however, motorized systems are typically illegal. Furthermore, motorized systems are also fairly expensive, which can be a particular problem for those who have already purchased motionless decoys.

For example, a typical hunter may spend upwards of several hundred dollars for a package of 10-12 conventional (i.e., motionless) decoys. By contrast, a single, motion-based decoy can cost as much as several hundreds of dollars alone, and can be even more expensive depending on the degree of realism provided by the intended movement. Since hunters tend to prefer using multiple decoys for simulating a flock of fowl, one can appreciate that purchasing 10-12 motion-based decoys can therefore be prohibitively expensive. Along similar lines, since a hunter already can spend large sums of money for a package of motionless decoys, the hunter may be less inclined to spend a significant additional sum simply to replace his non-motion-based decoys with motion-based decoys. This is particularly true in locales, as stated, in which motorized decoys are illegal.

Accordingly, an advantage in the art can be realized with motion-based fowl decoys that provide realistic motion at a relatively low cost. In addition, an advantage in the art can be realized with motion-based mechanisms that can be readily fitted onto conventional decoys.

### BRIEF SUMMARY OF THE INVENTION

Embodiments of the present invention solve one or more of the foregoing problems in the prior art with inexpensive, motion-based fowl decoy mechanisms. In particular, a conventional fowl decoy, as described herein, can be configured for natural movement, hence allowing a hunter to use motion-based decoys without incurring considerable costs.

A fowl decoy (or “decoy”) stand can be implemented with a conventional decoy to provide the conventional decoy with natural motion. One exemplary implementation includes a stand having a base and a support axis rising substantially through the center of the base, the support axis extending to a distal end. In some embodiments, the support axis can also form a point at the distal end. A mounting assembly includes a planar surface that can be molded or connected to a hollow shaft, the hollow shaft having an inner diameter that can substantially and/or flexibly fit around the support axis' distal end. The mounting assembly can be mounted to the underside of a conventional decoy, and can be rotatably coupled to the base on the other side.

In one embodiment, the mounting assembly tilts somewhat about the support axis, particularly when the support axis' distal end forms a point. Thus, when the mounting assembly is connected to a decoy body, the inventive stand can give the decoy body a sense of up, down, side-to-side, and diagonal wobble. In addition, because the mounting assembly can rotate about the support axis, the mounting assembly can also provide the decoy body with a sense of natural side-to-side turning. Aspects of the present invention, therefore, provide a decoy with natural movement at a relatively low manufacturing expense.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an overview perspective of a fowl decoy implementing aspects of an embodiment of the present invention;

FIGS. 2A-2B illustrate underside perspectives of a decoy stand in various stages of attachment to a decoy; and

FIGS. 3A-3B illustrate top view depictions of decoy movement when implementing an embodiment of a decoy stand with a fowl decoy.

### DETAILED DESCRIPTION OF THE PREFERRED EMBODIMENTS

Embodiments of the present invention include inexpensive, motion-based fowl decoy stands that can be implanted with conventional fowl decoys. Thus, a conventional fowl decoy, as described herein, can be configured for natural movement, hence allowing a hunter to use motion-based decoys without incurring considerable costs.

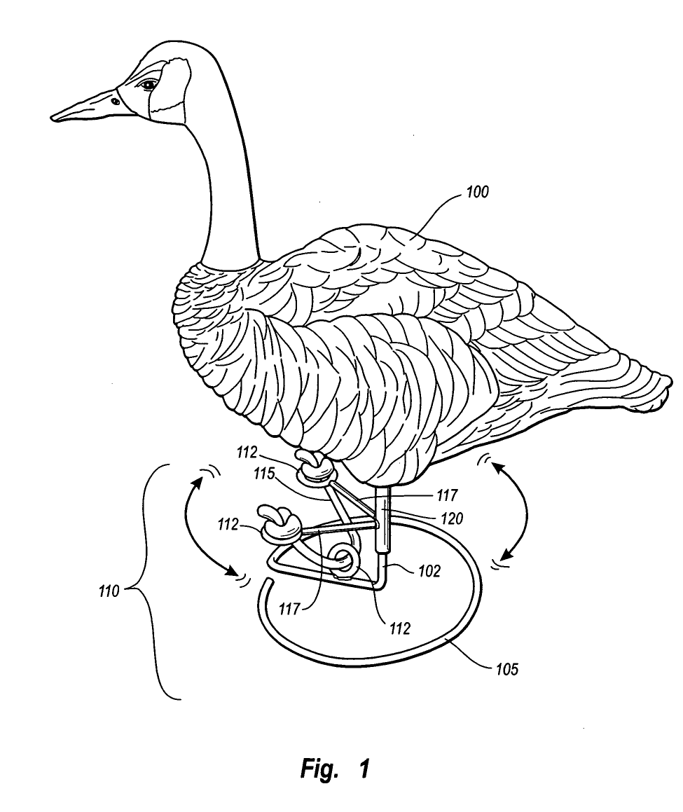

FIG. 1 illustrates an overview perspective of a fowl decoy that is configured to implement aspects of live fowl. In particular, the figure shows an exemplary implementation in which a fowl decoy 100 is mounted to a motion-based decoy stand 110. As will be discussed in greater detail herein, since the stand 110 is configured to give the decoy a certain amount of wobble and rotation, the stand 110 allows an otherwise motionless decoy to intimate live fowl movement.

As a preliminary matter, decoy 100 can be any conventional fowl decoy such as one that resembles a waterfowl, such as a duck or, goose, and any other type of fowl, such as a turkey, and so forth. Generally, decoys such as these often have detachable legs and/or feet. For example, the BIG FOOT goose decoy (not shown), which can be found through the 2003 Cabela's Inc. catalog (Sidney, Neb.), typically includes a set of legs and/or feet that can be easily separated from the base of the BIG FOOT body. The cavity (not shown) from which the legs of the BIG FOOT decoy (as well as similar cavities from other similar decoys) are removed provides an appropriate mounting point for receiving a motion-based stand as described herein. One of ordinary skill will also appreciate after reading this disclosure and claims, however, that any fowl decoy can be easily configured to accommodate aspects of the present invention. For example, floatation based decoys (not shown) that are typically sold without legs or feet can also be configured in a similar manner.

Continuing with FIG. 1, fowl decoy stand 110 includes a base support means, such as base 105. In at least one embodiment, base support means 105 comprises a single metal bar that is formed so that it is bent in at least three or more points to form one of a circular base, a square base, and a rectangular base for stabilizing the decoy 100 when mounted to the stand 110. The base 105 can also comprise injection molded plastics formed in the circular (as well as square, triangle, and rectangle, etc.) shape illustrated that is formed with an extension support, or support axis 102 that extends upwardly through a center portion of the base 105. Within the scope of the invention, a manufacturer of the inventive stand 110 can choose any of the foregoing materials to make the base 105, as well as any similar materials that can provide comparable stabilizing properties at a relatively low cost.

As also shown in FIG. 1, stand 110 can include a plurality of thread-through attachments 112, or eyelets, into which a user or manufacturer can secure flexible restraint means, such as restraining member 115. Generally, at least two attachments 112 are coupled to the mounting assembly 120, and at least one attachment 112 is coupled to the base 105. Alternatively, two or more attachments 112 are coupled to the base 105, and one or more attachments 112 are coupled to the mounting assembly 120. The arrangement of the attachments 112 on the decoy stand 110, therefore, is not limiting.

In any case, although the attachments 112 are shown as threading eyelets for the purposes of convenience, it is appreciated that other attachment means are possible within the scope of the invention. For example, other attachment means can include hooks, such as an s-hook, clamps, cotter pin assemblies, and so forth, each of which allow the restraining member 115 to rotatably couple the base 105 and mounting assembly 120. Still, however a manufacturer secures the restraining member 115 to two or more of the attachment means 112, it is important that the restraining member 115 remain relatively secured to the stand 110. That is, the restraining member 115 is secured to the arms 117 extending from the mounting assembly 120, but slidably-threaded through the attachment 112 that is connected to the base 105. Securing the restraining member 115 in this manner can be particularly important when the decoy is used in rough weather conditions.

FIG. 1 also shows that a plurality of arm extensions 117 can aid securing the restraining member 115 to the decoy stand 110. In at least one embodiment, arm extensions 117 extend directly from the mounting assembly 120. One will appreciate, however, that arm extensions 117 can also be attached from the base 105 in addition to, or in lieu of, any arm extensions 117 that have been attached to the mounting assembly 120. In any case, arm extensions 117 can be mounted to the decoy stand 110 through common welding techniques in the case of metals, or similar securing means in a plastics manufacturing process. One will appreciate that the arm extensions 117 should be attached at least in such a way that the arm extensions 117 remain secured to the stand 110 in rough weather conditions.

The use of the arm extensions 117, attachments 112, and restraining member 115 allow the decoy to rotate in a limited manner such that the decoy does not rotate a full 360°. For example, a manufacturer can space the arm extensions so that the decoy 100 can only rotate between 0° and 180°, when threaded with restraining member 115. In particular, greater spacing between the arm extensions 117 allows for greater decoy 100 rotation, at least in part since greater spacing requires a longer length of restraining member 115. Hence, the manufacturer can also expand or minimize the decoy's rotation angle based on the composition of the restraining member, or flexible restraint means 115. For example, a more flexible restraining member 115 can comprise a flexible bungee cord that accommodates a greater rotation angle than a more restraining restraining member 115 that comprises relatively inflexible materials, such as nylon rope. Hence, a manufacturer can adjust both the arm extension spacing 117 and the restraint means 115 composition to ensure a realistic amount of rotation angle.

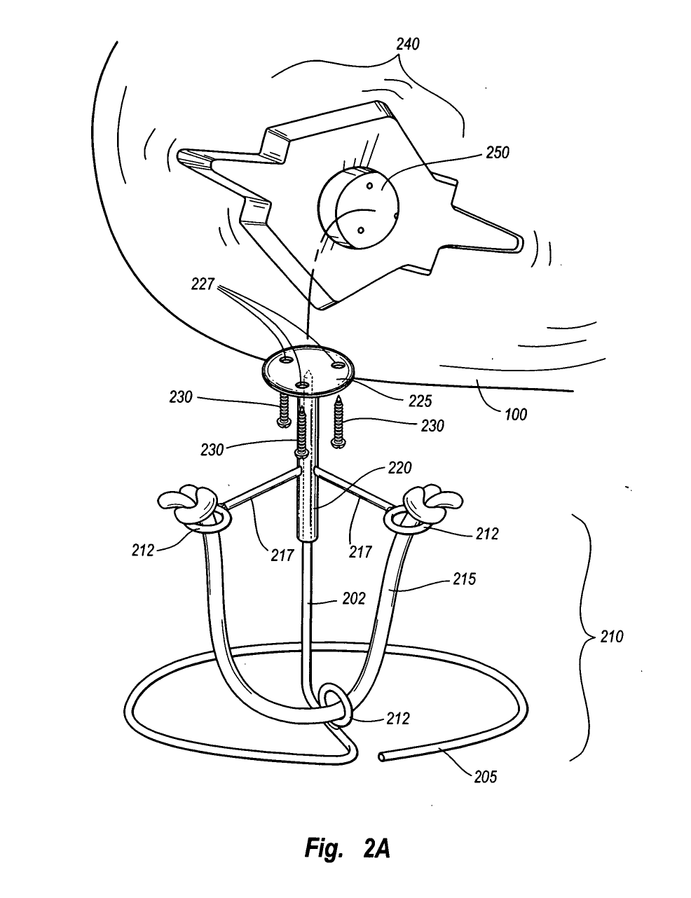

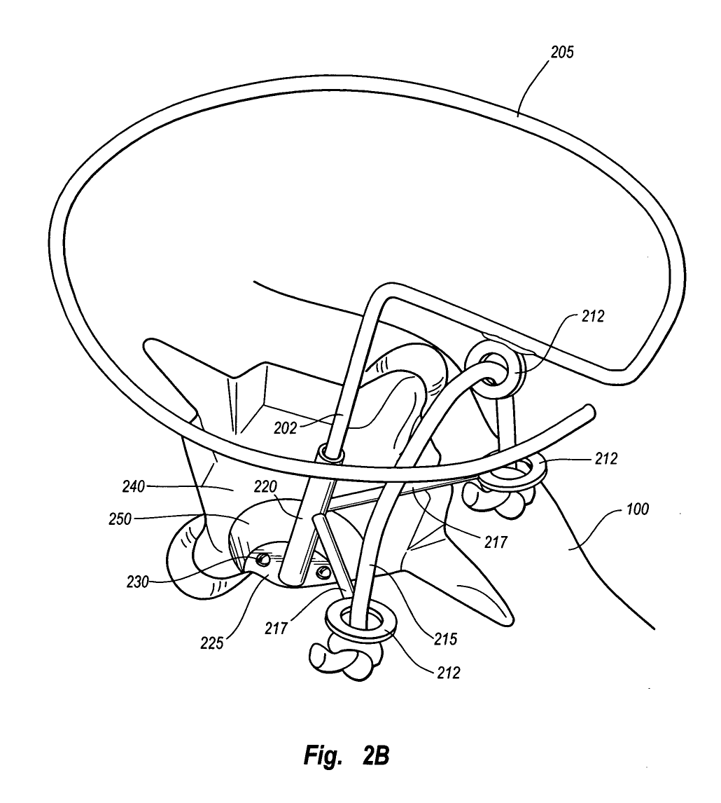

FIG. 2A illustrates an underside perspective of the decoy and decoy stand prior to mounting the mounting means of the decoy stand 210 to the decoy 200. As in FIG. 1A, a decoy stand 210 includes a base support means, such as base 205 and a support axis 202, the base 205 and support axis 202 being rotatably coupled to mounting means, such as mounting assembly 220. FIG. 2A also shows, however, that an extension support, such as support axis 202, can be slidably positioned within pivot reception means, such as a hollow shaft of the mounting means, or mounting assembly 220. In such an embodiment, support axis 202 can be manufactured separately from the mounting assembly 220. Hence, mounting assembly 220 can also comprise materials, such as plastics, that are distinct from the materials of which the base 205 and support axis 202 comprise, such as metals, and vice versa. The composition of each specific material for each stand 210 component can be based on a variety of factors, including whatever sufficiently strong materials are available to the manufacturer at the lowest cost.

FIG. 2A also shows that the support axis 202 can form a point at a distal end upon which the mounting assembly 220 rests. In such a case, the support axis 202 is configured so that it pivots against the mounting assembly 220 when the mounting assembly 220 can include attachment interface means, such as a primarily planar portion 225. In at least one embodiment, a pivoting arrangement such as this between the support axis 202 and planar mounting surface 225 allows the mounting assembly 220 to have a certain amount of side-to-side, front-to-back, and diagonal wobble, as well as wobble based on random combinations of the foregoing. Furthermore, pivotal abutment between the mounting surface 225 and the support axis 202, which has been formed to a point at the distal end, allows more fluid rotation of the mounting assembly 220 about the axis 202. Fluid rotation can allow the decoy stand 210 to exhibit natural fowl movements with only the slightest of stimuli, such as a gentle wind. As such portion 225 can also aid these movements by being configured with other imperfect geometric shapes, such as a surface having a central apex (not shown).

Although there are many acceptable methods for mounting the stand 210 to a decoy 200, one method is described herein for the purposes of convenience. In addition, one will also appreciate after reading the disclosure and claims that the described order of mounting the decoy stand 210 to the decoy 200 is not important. Accordingly, implementing the stand 210 to a decoy 200 comprises a number of acts that can be performed in any order. For example, in one step, the user will remove any decoy 200 legs, if applicable, such as detachable legs (not shown) on a standard BIG FOOT decoy (not shown).

In some conventional decoys, leg removal leaves an inner mounting surface 240, which is generally on an underside area of the decoy 200, and in some cases also leaves an additional mounting cavity 250 within the mounting surface 240. One will appreciate, therefore, that the mounting assembly 220 can be configured for any decoy 200 so that the mounting assembly 220 can be slidably positioned within the cavity 250. Alternatively, the mounting assembly 220 can be manufactured so that it has a planar surface 225 that easily accommodates a mounting surface 240 of any conventional decoy 200.

In at least one embodiment, a user also places the mounting assembly 220 against the decoy at a decoy mounting surface 240 (or 250, if applicable) so that perforations 227 in the attachment interface means 225 correspond to previously prepared perforations on the decoy 200. Corresponding perforations in the decoy are not, however, required, though they may be present after the removal of decoy legs from a conventional decoy. In any case, once the user has positioned the mounting plate 225 against the decoy 200 in an appropriate position, the user can then fasten the mounting plate 225 to the decoy using one or more fasteners 230, such as screws, adhesives, glues, etc.

Generally, one will appreciate that any type of fastener 230 will suffice to attach the stand 210 to a decoy 200, so long as the mounting assembly 220 rests securely against the decoy. Ideal fasteners in accordance with the present invention, however, allow the user to repeatedly add and remove the mounting assembly 220 as appropriate, with only minimal effect on the decoy 200. For example, fasteners 230 that are more readily suited for repeated adding and removing can comprise standard screw and washer assemblies. The ability to add and remove in this manner can be important in implementations such as when a fowl hunter desires to use the decoy alternatively as a floating decoy when not in use for standing in a field.

A user or manufacturer can also secure the stand 210 to the decoy by coupling the base support means, such as base 205, to the mounting assembly 220, which can include an act of inserting the support axis 202 into a hollow shaft in the mounting assembly 220. At any time prior to or after securing the mounting assembly 220 to the decoy mounting surface 240 (or 250 if applicable), the user or manufacturer threads a restraining member 215 into attachments 212, such as corresponding attachments 212 on the base 205, and on the arm extensions 217. As previously described, the restraining member 212 can be secured to one or more of the attachments through a simple knot, a cotter pin assembly, and so forth. FIG. 2B illustrates an alternative underside perspective view of FIG. 2A in which the decoy stand 210 has been mounted to the decoy 200.

Generally, a motion-based stand 210 in accordance with aspects of the present invention can be manufactured by an industrial metals manufacturer or even a user at home with appropriate tools by performing any number of the following acts. One will also appreciate after reading the disclosure and claims, however, that although the following description includes certain acts for manufacturing a motion based stand, the following acts do not need to be performed in any particular order, and can be added to or substituted with other acts not described, as appropriate. Furthermore, although the following acts are not illustrated specifically in the Figures of this application, it is understood that the following acts are suitable for manufacturing a decoy stand 110, 210, or 310, as previously described, and hence is described with reference to FIGS. 2A-2B for convenience.

Accordingly, a method for manufacturing a motion-based decoy stand (e.g., 210) includes an act of forming a base. In at least one embodiment, a manufacturer forms a rod to incorporate a plurality of bends, wherein the rod comprises a base 205 that substantially forms one of a circular base, a square base, a triangular base, and a rectangular base. This can be done using a series of appropriate tools, such as one or more clamps, and, in some cases of metals, can involve use of welding equipment to momentarily soften the rod.

In some embodiments, the method for manufacturing the stand can also include an act of forming a support axis that extends upwardly through a central position of the base. This can be done by bending another portion of a rod toward a central portion of the base portion 205, and so that the rod extends upwardly from the base 205 to create a central axis, or support axis 202. The manufacturer can then shave the distal end of the support axis 202, as desired, so that it forms a point.

The stand 210 also includes a mounting assembly that will be mounted over the base 205. Manufacturing the mounting assembly 202 can include forming a mounting assembly having a hollow shaft and pivot reception means, the mounting assembly configured to mount against an underside portion of a fowl decoy. For example, the manufacturer may select hollow shaft materials that have dimensions sufficient to fit around support axis 202. The manufacturer can then secure the hollow shaft to a pivot reception means than can include a substantially planar surface, such as mounting interface 225. In some cases, the manufacturer will secure the pivot reception means 225 to the support axis 202 using conventional welding techniques, and will perforate portions of the mounting interface 225 so that fasteners can couple the mounting assembly 220 to a decoy 200.

Attachments 212 at various points on the mounting assembly 220 and base 205 help couple the base 205 and mounting assembly 220 together. Thus, a method for creating the decoy stand 210 also includes assembling a plurality of attachments 212 to one or more of the base 205 and the mounting assembly 220. For example, a manufacturer can weld metal attachments 212 to metal arm extensions 217, and can also weld one or more attachments 212 directly to the base 205. Similar steps, other than welding, can be taken with injection-molding processes. As previously described, the attachments 212 can include metallic eyelets, as depicted in FIGS. 1 and 2A-2B, as well as other types of attachment means.

With the attachments 212 in place, the method of manufacturing the decoy stand 210 also includes coupling the base 205 and mounting assembly 220 such that a restraining member 215 that has been threaded through at least one of the attachments limits the mounting assembly from rotating 360° with respect to the base. In particular, a manufacturer can thread a restraining member 215, such as flexible or inflexible restraint 215 (e.g., bungee cord or nylon rope, respectively) through the attachments 212, and then secure the restraining member 215 to one or more of the attachments 212. In more simple cases, the manufacturer can implement securing means on the restraining member 215 such as tying a knot at the end of the restraining member 215 after it has been threaded through an attachment 212, as shown in FIGS. 1, and 2A-2B. One will appreciate, however, that more complicated securing means can be implemented, such as the use of cotter pin assemblies, and so forth.

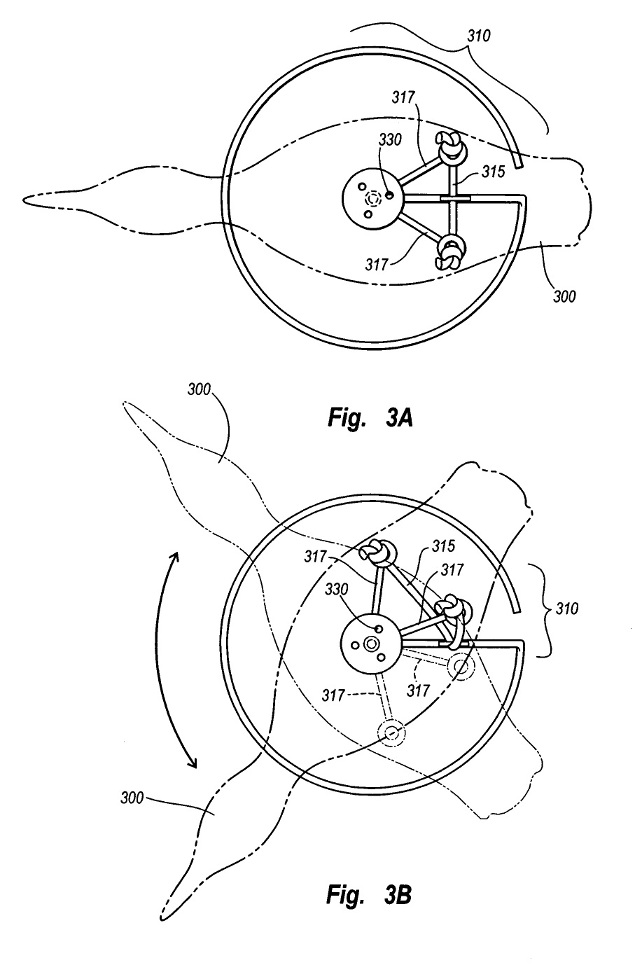

FIGS. 3A-3B illustrate top view depictions of decoy movement when implementing an embodiment of a decoy stand as described herein. For example, FIG. 3A shows a decoy 300 connected to the motion-based stand 310 when in a standard position. One of ordinary skill will note that, in at least one exemplary embodiment, the arm extensions 317 are spaced such that they cannot be seen extending outside a width or length dimension of the fowl 300, when viewed from above. This can be particularly helpful in simulating live fowl it can obscure obvious artifice from fowl flying overhead.

FIG. 3B shows that the base allows minimal rotation capability of the fowl decoy 300 about an axis provided by support axis 202. In particular, the elastomeric member 315 and attachments 212 generally prohibit the decoy 300 from complete 360° rotation about the axis provided by support axis 202. In particular, since the decoy 300 rotates at an angle that is typically much less than 360° rotation, the stand 310 allows the decoy 300 to intimate the natural bobs and side-to-side glances of a fowl that is foraging on the ground.

Accordingly, aspects of the described embodiments allow hunters to implement natural movement with decoys. In particular, aspects of the present invention allow hunters to implement natural movement with their previously-purchased conventional, otherwise-motionless decoys, as well as previously purchased decoys that implement less-than-natural movement.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A motion-based decoy stand comprising;
a base having a support axis extending therefrom; and
a mounting assembly configured for pivotal abutment with the support axis,- on one side, and for mounting to a decoy on an opposing side, such that the rotation of the mounting assembly about the base is limited;
wherein the mounting assembly allows the decoy to perform one or more of a wobbling and rotating motion about the support axis in response to a natural stimulus.

2. The stand as recited in claim 1, wherein the mounting assembly comprises an attachment interface that is configured to mount to any of a duck, goose, or turkey decoy.

3. The stand as recited in claim 1, wherein a plurality of arms extend from one of: (i) the base; and (ii) the mounting assembly, and wherein a flexible restraining member is secured to one or more of the plurality of arms.

4. The stand as recited in claim 1, wherein at least one arm extends from one of: (i) the base; and (ii) the mounting assembly.

5. The stand as recited in claim 4, wherein a flexible restraining member is secured to the at least one arm that extends from one of: (i) the base and; (ii) the mounting assembly.

6. A motion-based decoy stand comprising:
a base having a support axis; and
means for rotatably coupling a decoy about the base, such that rotation of the decoy about the base is limited, and such that the decoy can wobble as it rotates.

7. The motion-based decoy stand as recited in claim 6, wherein means for rotatably coupling comprises a mounting assembly rotatably mounted to the base, the stand being configured such that the rotation of the mounting assembly about the base is limited.

8. The motion-based decoy stand as recited in claim 6, further comprising:
a plurality of arms extending from one of the base and the mounting assembly; and
a restraining member secured to one or more of the plurality of arms that extend from one of the base and the mounting assembly.

9. The motion-based decoy stand as recited in claim 6, wherein the support axis forms a pivot that is removably inserted within the means for rotatably coupling a decoy about the base, such that pivotal abutment between the support axis and the means for rotatably coupling the decoy allow the decoy to wobble as it rotates.

10. The motion-based decoy stand as recited in claim 6, wherein means for rotatably coupling a decoy about the base is limited to rotating about the support axis at a rotation angle that is less than 360°.

11. The motion-based decoy stand as recited in claim 6, wherein the base comprises a single metallic rod that has been bent in a plurality of points to form one of a circular, square, and rectangular base.

12. The motion-based decoy stand as recited in claim 6, wherein the means for rotatably coupling a decoy about the base is mounted through the attachment interface to any of a duck, a goose, or a turkey decoy.

13. The motion-based decoy stand as recited in claim 6, wherein the decoy stand comprises one or more attachments through which is threaded a flexible restraining member comprising one of a rope, rubber, and a bungee restraining member.

14. The motion-based decoy stand as recited in claim 13 wherein the one or more attachments connect to one or more arms extending from one of: (i) the base; and (ii) the means for rotating the decoy.

15. The motion-based decoy stand as recited in claim 14, wherein the restraining member and the one or more attachments couple the means for rotating the decoy to the base.

16. A motion-based decoy stand comprising:
a base configured to rest on a support surface without being secured thereon;
a mounting assembly mounted on the base;
one or more arms extending from at least one of: (i) the base; and (ii) the mounting assembly; and
a flexible restraining member coupling the mounting assembly to the base, such that the flexible restraining member limits rotation of the mounting assembly about the base.

17. The motion-based decoy stand as recited in claim 16, wherein the base comprises a single metallic rod that has been bent in a plurality of points to form one of a circle, square, and rectangular base.

18. The motion-based decoy stand as recited in claim 16, wherein the mounting assembly is modifiable to fit to the underside of any of a duck, goose, or turkey decoy.

19. The motion-based decoy stand as recited in claim 18, wherein a support axis arising from the base forms a point at the distal end, and wherein the mounting assembly mounts over the point, such that the mounting assembly can wobble as it swivels about the point with respect to the base.

20. The motion-based decoy stand as recited in claim 16, wherein the flexible restraining member comprises one or more of flexible rope, rubber, spring, and bungee materials.

21. The motion-based decoy stand as recited in claim 20, wherein the flexible restraining member connects the mounting assembly with the base via one or more attachments.

22. A method of manufacturing a motion-based decoy stand comprising:
bending a metal rod at one or more points to form a base having a support axis extending therefrom;
forming a mounting assembly configured to mount against an underside portion of a fowl decoy on one side, and to pivotally abut the support axis on an opposing side; and
coupling the base and mounting assembly with a flexible restraining member, such that the mounting assembly is limited from rotating 360° with respect to the base in response to a natural stimulus.

23. The method as recited in claim 22, wherein the flexible restraint comprises one or more of bungee, rubber, and nylon rope materials, and wherein the base comprises one or more of metal and injection molded plastic.

24. The method as recited in claim 22, further comprising welding the attachments to at least one of the base and the mounting assembly.

25. The method as recited in claim 22, further comprising perforating one or more portions of the mounting assembly so that the mounting assembly can be nailed or screwed to the underside of any of a duck, goose, or turkey decoy.
